(19) United States
(12) Patent Application Publication
(10) Pub. No.: US 2009/0239095 A1
(43) Pub. Date: Sep. 24, 2009

(54) COMPOSITE RODS AND PROCESSES FOR FORMING COMPOSITE RODS

(75) Inventors: Vinay M. Desai, Auburn, ME (US); David W. Littlefield, Gardiner, ME (US); James A. Granese, New Gloucester, ME (US)

Correspondence Address: PATRICK R. SCANLON;PRETI FLAHERTY BELIVEAU & PACHIOS LLP, ONE CITY CENTER, PORTLAND, ME, 04112-9546, US

(73) Assignee: Elmet Technologies, Inc., Lewiston, ME (US)

(21) Appl. No.: 12/409,182

(22) Filed: Mar. 23, 2009

Related U.S. Application Data
(60) Provisional application No. 61/038,754, filed on Mar. 23, 2008.

(51) Int. Cl. B32B 15/01; B21D 31/00

(52) U.S. Cl. 428/665; 72/364

(57) ABSTRACT

A composite rod includes an outer sleeve formed over an inner core, wherein the outer sleeve and the inner core are joined with a non-metallurgical bond that provides a tight fit therebetween. A process for forming a composite rod includes positioning a rod inside a tube to form an intermediate assembly, wherein the tube has an inside diameter that is greater than the outside diameter of the rod. The tube is then compressed around the rod to produce a non-metallurgical bond between the tube and the rod.

### CROSS REFERENCES TO RELATED APPLICATIONS

This application claims the benefit of U.S. Provisional Application No. 61/038,754, filed Mar. 23, 2008.

### BACKGROUND OF THE INVENTION

There are numerous uses and applications for composite rods that comprise an outer sleeve formed over an inner core. For many composite rod applications, it is beneficial to have a seamless interface (i.e., no gaps) between the outer sleeve and inner core. For instance, a gap between the core and sleeve could adversely affect heat transfer in the composite rod for some applications.

### SUMMARY OF THE INVENTION

A composite rod in accordance with one embodiment includes an outer sleeve formed over an inner core, wherein the outer sleeve and the inner core are joined with a non-metallurgical bond that provides a tight fit therebetween. A process for forming a composite rod includes positioning a rod inside a tube to form an intermediate assembly, wherein the tube has an inside diameter that is greater than the outside diameter of the rod. The tube is then compressed around the rod to produce a non-metallurgical bond between the tube and the rod.

### DESCRIPTION OF THE DRAWINGS

FIG. 1 is a cross-sectional view of an intermediate assembly used in forming a composite rod.

FIG. 2 is an end view of the assembly of FIG. 1.

FIG. 3 is a cross-sectional view of a formed composite rod.

FIG. 4 is an end view of the composite rod of FIG. 3.

FIG. 5 is a cross-sectional view of a formed composite rod having end caps attached.

### DETAILED DESCRIPTION OF THE INVENTION

The present invention generally relates to composite rods and processes for forming composite rods. One such process for forming composite rods can include bonding an outer sleeve onto an inner core without a metallurgical bond and without any gaps between the sleeve and core. That is, the process produces an airtight, gapless, non-metallurgical bond between the sleeve and core. As used herein, the term “non-metallurgical bond” refers to a bond between two articles wherein no intermelting or diffusion of the respective materials occurs.

Referring to FIGS. 1-5, one embodiment of a process for forming composite rods begins with obtaining a tube 10 and a separate rod 12. The tube 10 is made of the material that the outer sleeve of the composite rod is to be, and the rod 12 is made of the material that the inner core of the composite rod is to be. Although they can be the same material, the two components will typically comprise dissimilar materials. The inside diameter (ID) of the tube 10 is greater than the outside diameter (OD) of the rod 12. The tube 10 and rod 12 can be, but are not necessarily, equal in length.

The tube 10 and rod 12 are arranged with the rod 12 positioned inside of the tube 10 to create an intermediate assembly 14 as shown in FIGS. 1 and 2. The intermediate assembly 14 then undergoes a rotary forging operation that compresses the tube 10 around the rod 12, resulting in a tight fit between these two components. The intermediate assembly 14 can be heated prior to the forging operation. The heating can be accomplished by any suitable means, such as in a furnace. If pre-heating is used, it will be done at relatively low temperatures so as to prevent the formation of a metallurgical bond between the tube 10 and rod 12.

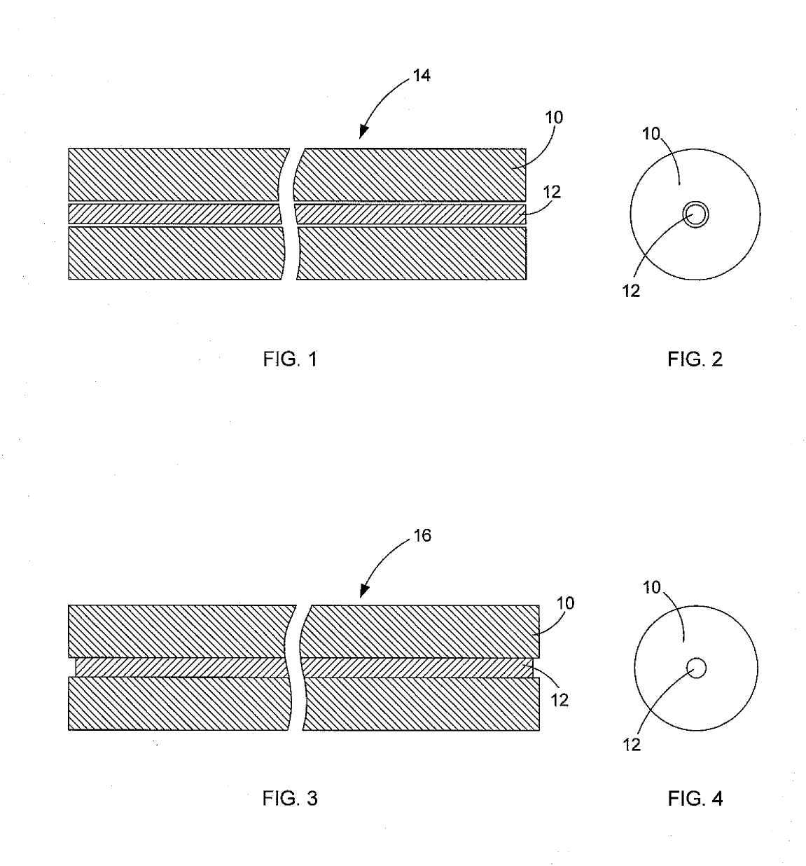

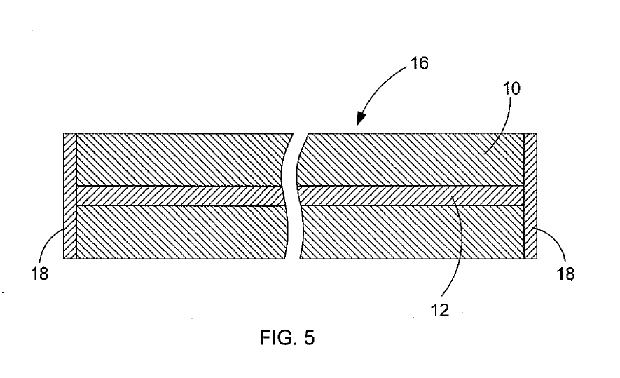

The forging operation can be performed with a rotary swager, using dies made up of two or more segments. As the intermediate assembly 14 is moved between the swager dies, the dies apply radial forces to the outer surface of the tube 10 in rapid succession. These forces bond the tube 10 to the rod 12 forming the composite rod 16 (shown in FIGS. 3 and 4) wherein the tube 10 becomes the outer sleeve of the composite rod 16 and the rod 12 becomes the inner core of the composite rod 16. This process mechanically bonds the tube 10 to the rod 12 with a full contact interface between the two components. That is, there are no gaps between the outer sleeve 10 and the inner core 12 of the composite rod 16. The gapless interface is achieved without a metallurgical bond because the forging temperature is maintained at a sufficiently low level to prevent metallurgical bonding.

As an alternative to a full contact, gapless interface, the tight fit between the tube 10 and the rod 12 can comprise a low clearance interface. That is, an interface or fit between the two components that is not necessarily full contact or gapless, but has no more than a minimal clearance, typically about 2 thousandths of an inch or less.

The operation reduces the outside diameter of the tube 10, but is conducted in such a manner so as to produce no deformation of the inner rod 12. Since the material volume of the tube 10 remains constant, reducing its cross-sectional area results in an increase in length of the tube 10, as shown in FIGS. 3 and 4. The process is particularly useful for, but not limited to, forming composite rods of relatively long lengths (e.g., about one foot or longer).

In one embodiment, one or both ends of the composite rod 16 can be closed or capped by joining a piece of material thereto. Referring to FIG. 5, a disc 18 is welded to each end of the composite rod 16. The discs 18 have a diameter equal to the outside diameter of the sleeve 10 after the forging operation and are preferably made from the same material as the sleeve 10. To prepare the composite rod ends for welding, each end will be cut square using any suitable means, such an abrasive cutting wheel. The end of the composite rod 16 can be beveled to accommodate the weld.

The composite rod 16 can undergo additional finishing operations. For instance, the composite rod 16 can be centerless ground or otherwise machined to the desired final diameter.

The process described herein can be used to make composite rods for any application and can be applied to any combination of rod and tube diameters and materials, as long as attention is paid to deformation, melting and reaction temperatures of the components. Furthermore, while the deformation process described herein was swaging, a drawing operation or a rolling operation could also be used. For example, a rolling operation could comprise passing the intermediate assembly 14 through several stages of form rolls, thereby compressing the tube 10 around the rod 12 to produce a tight fit and non-metallurgical bond between these two components.

In one example of a process to make a composite rod, a 0.187-inch tungsten centerless ground rod was joined with a tube made of Inconel 600 nickel-base alloy and having an OD of 0.380 inches and an ID of 0.197 inches. Both the rod and the tube were cut to 6 feet in length.

The tungsten rod was slid inside the Inconel tube, and the two together were transported through a pre-heat furnace where process temperatures (swaging preheat temperature) were in the range of 1100-1150° C. The rod-tube assembly was then transported into a rotary swaging machine. The rotary swager was set up such that there would be a net deformation of the OD of the tube that exceeded the diameter difference between the tungsten rod and the Inconel tube ID. In this case, the OD after the swaging operation was 0.365 inches, with a total deformation of 0.015 inches, which was greater than the Inconel tube ID-tungsten rod OD difference of 0.010 inches (0.197 inches minus 0.187 inches). A secondary smooth swaging operation was also performed to further reduce the diameter of the composite from 0.365 inches to 0.360 inches—done primarily to assure a straighter rod, (but was not necessary to achieve the closure of the original gap between the Inconel tube and the tungsten rod).

The tungsten core was not deformed and did not elongate. The Inconel sleeve elongated and stretched over the end of the tungsten core rod. There was no gap between the core rod and the Inconel tube.

What is claimed is:

1. A process for forming a composite rod, said process comprising:
providing a rod having an outside diameter;
providing a tube having an inside diameter that is greater than said outside diameter of said rod;
positioning said rod inside said tube to form an intermediate assembly; and
compressing said tube around said rod to produce a non-metallurgical bond between said tube and said rod.

2. The process of claim 1 wherein compressing said tube around said rod includes a rotary forging operation.

3. The process of claim 2 wherein said rotary forging operation is performed with a rotary swager.

4. The process of claim 2 further comprising heating said intermediate assembly prior to said rotary forging operation.

5. The process of claim 4 wherein said heating is done at temperatures low enough to prevent formation of a metallurgical bond between said tube and said rod.

6. The process of claim 2 wherein compressing said tube around said rod to produce a non-metallurgical bond between said tube and said rod results in a tight fit between said tube and said rod.

7. The process of claim 6 wherein said tight fit is a full contact interface.

8. The process of claim 6 wherein said tight fit is a low clearance interface.

9. The process of claim 1 wherein compressing said tube around said rod is conducted so as to produce no deformation of said rod.

10. The process of claim 1 wherein said tube and said rod comprise dissimilar materials.

11. A composite rod comprising an outer sleeve formed over an inner core, wherein said outer sleeve and said inner core are joined with a non-metallurgical bond that provides a tight fit between said outer sleeve and said inner core.

12. The composite rod of claim 11 wherein said tight fit is a full contact interface.

13. The composite rod of claim 11 wherein said tight fit is a low clearance interface.

14. The composite rod of claim 11 wherein said outer sleeve and said inner core comprise dissimilar materials.

15. The composite rod of claim 14 wherein said outer sleeve comprises a nickel-base alloy and said inner core comprises tungsten.
